(19) United States
(12) Patent Application Publication
(10) Pub. No.: US 2026/0172702 A1
(43) Pub. Date: Jun. 18, 2026

(54) MEDICAL GRADE COLOR FILTERS

(71) Applicant: OMNIVISION TECHNOLOGIES, INC., Santa Clara, CA (US)

(72) Inventors: Paul Wickboldt, Walnut Creek, CA (US); Yuxin Wang, Palatine, IL (US)

(73) Assignee: OMNIVISION TECHNOLOGIES, INC., Santa Clara, CA (US)

(21) Appl. No.: 18/978,344

(22) Filed: Dec. 12, 2024

(51) Int. Cl. H04N 25/13; G02B 5/20; H04N 23/56

(52) U.S. Cl. CPC H04N 25/135; G02B 5/201; H04N 23/56

(57) ABSTRACT

A system for generating color-accurate images of biological tissue is disclosed herein, including an image sensor configured to capture and transmit an image of biological tissue and a processor configured to receive and display the image of biological tissue. The image sensor may include a pixel array, a light source, and a control unit. The pixel array may include a plurality of subpixels and a plurality of color filters. Each subpixel may include at least one photodiode. The plurality of color filters may include a red wavelength high-pass color filter, an orange wavelength high-pass color filter, a green wavelength band-pass color filter, and a blue wavelength band-pass color filter. The control unit may be electrically coupled to the pixel array and the light source.

### BACKGROUND INFORMATION

### Field of the Disclosure

This disclosure relates generally to color filters for image sensors, particularly—but not exclusively—relates to color filters for CMOS image sensors with color-accurate images of biological (e.g., human) tissue.

### Background

CMOS image sensors (CIS) have become ubiquitous. They are widely used in digital still cameras, cellular phones, security cameras, as well as medical, automobile, and other applications. The typical image sensor operates in response to image light reflected from an external scene and then being incident upon the image sensor. The image sensor includes an array of pixels having photosensitive elements (e.g., photodiodes) that absorb a portion of the incident image light and generate image charge upon absorption of the image light. The image charge of each of the pixels may be measured as an output voltage of each photosensitive element that varies as a function of the incident image light. In other words, the amount of image charge generated is proportional to the intensity of the image light, which is utilized to produce a digital image (i.e., image data) representing the external scene.

In some situations, a higher color precision is needed for imaging, while the conventional image sensors do not necessarily possess such capability to generate, for example, high contrast images. Accordingly, systems and methods for improved imaging precision are needed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Non-limiting and non-exhaustive embodiments of the present invention are described with reference to the following figures, wherein like reference numerals refer to like parts throughout the various views unless otherwise specified. The patent or application file contains at least one drawing executed in color. Copies of this patent or patent application publication with color drawing(s) will be provided by the Office upon request and payment of the necessary fee. FIG. 1A, FIG. 1B, and FIG. 1C illustrate non-limiting example embodiments of a pixel array, according to various aspects of the present disclosure.

FIG. 1A, FIG. 1B, and FIG. 1C illustrate non-limiting example embodiments of a pixel array, according to various aspects of the present disclosure.

FIG. 2 illustrates a non-limiting example embodiment of a system for generating color-accurate images of biological tissue, according to various aspects of the present disclosure.

FIG. 3A is a graphical depiction of the sRGB color space and the Rec. 2020 color space within the context of the full range of human vision, according to the CIE 1931 Standard.

FIG. 3B illustrates a non-limiting example embodiment of a simulated color filter response, according to various aspects of the conventional technology.

FIG. 3C illustrates a non-limiting example embodiment of a simulated color filter response, according to various aspects of the present disclosure.

FIG. 3D illustrates non-limiting example embodiments of simulated color filter responses, according to various aspects of both the conventional technology and the present disclosure.

FIG. 4A and FIG. 4B illustrate a non-limiting example embodiment of a simulated color filter response, according to various aspects of the present disclosure.

FIG. 5A and FIG. 5B illustrate performance results of the non-limiting example embodiments of color filters according to various aspects of both the conventional technology and the present disclosure.

FIG. 6A and FIG. 6B illustrate performance results of the non-limiting example embodiments of color filters according to various aspects of both the conventional technology and the present disclosure.

FIG. 7 illustrates a method for generating and displaying color-accurate images of biological tissue, according to various aspects of the present disclosure.

### DETAILED DESCRIPTION

Examples of apparatus, system, and method for generating color-accurate images of biological (e.g., human) tissue are disclosed herein. Thus, in the following description numerous specific details are set forth to provide a thorough understanding of the examples. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one example” or “one embodiment” means that a particular feature, structure, or characteristic described in connection with the example is included in at least one example of the present invention. Thus, the appearances of the phrases “in one example” or “in one embodiment” in various places throughout this specification are not necessarily all referring to the same example. Furthermore, the particular features, structures, or characteristics may be combined in any suitable manner in one or more examples.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly.

Additionally, it will also be understood that when a layer is referred to as being “between” two layers, it can be the only layer between the two layers, or one or more intervening layers may also be present. Similarly, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Where methods are described, the methods may include more, fewer, or other steps. Additionally, steps may be performed in any suitable order. Accordingly, the disclosure can encompass other embodiments not expressly shown or described herein. In the context of this disclosure, the terms “about,” “approximately,” etc., mean +/−5% of the stated value.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

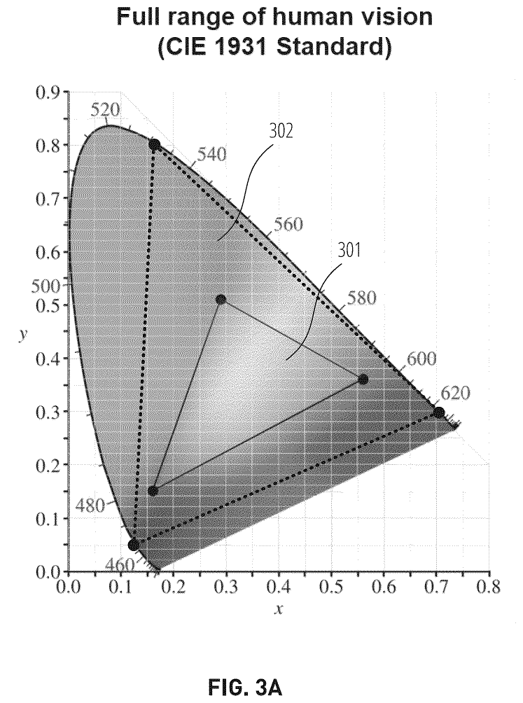

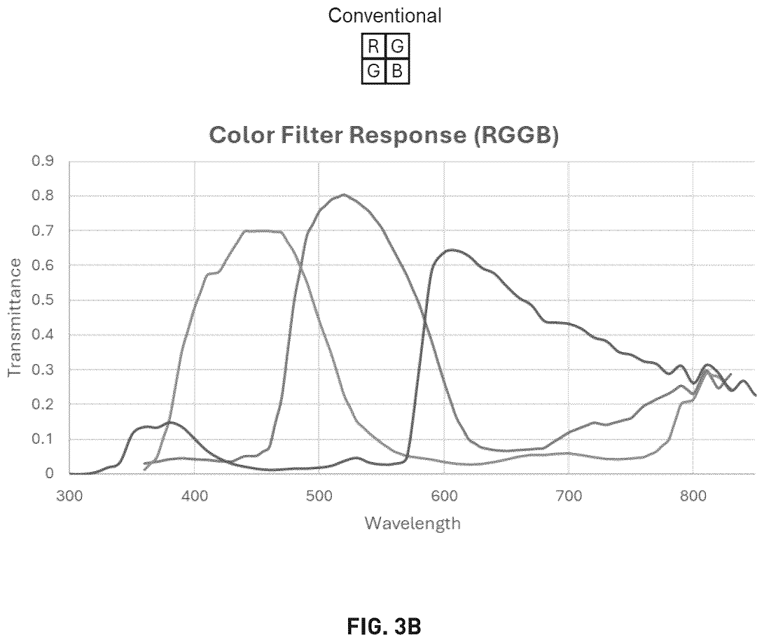

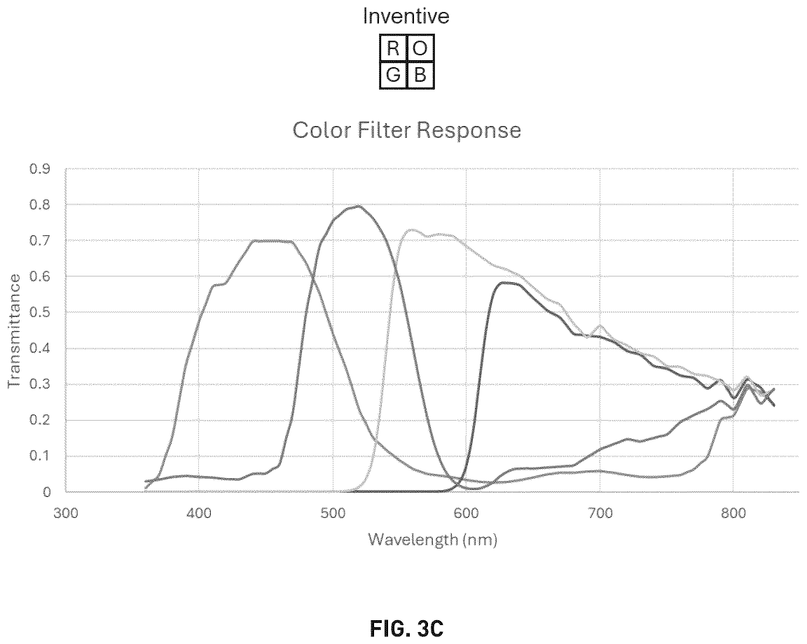

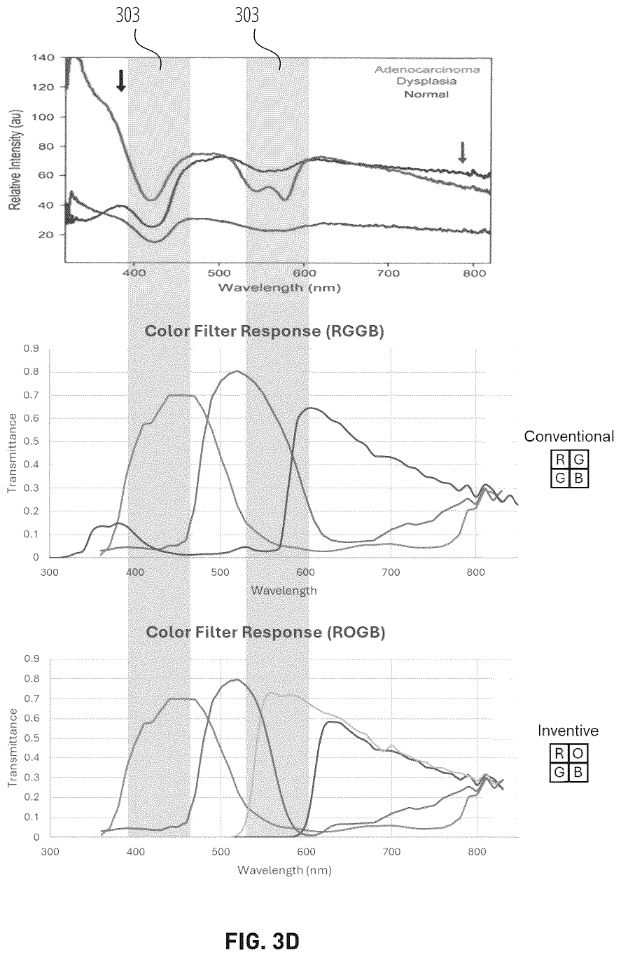

Briefly, when capturing color images, a conventional image sensor is designed to work within a standard display color space (sRGB), which only captures a fraction of the full range of human vision reflected in the CIE 1931 standard (see FIG. 3A). In medical applications, image sensors require higher color precision to adequately capture images of human tissue. In the context of this specification, references are made to acquiring images of the human tissue, however, a person of ordinary skill would understand that the inventive technology may be applicable to acquiring images of other biological tissue, for example, biological tissue of animals. This, in turn, requires higher contrast images that allow a user to distinguish between different types of tissue, as human tissue colors are clustered in the “reds” region of the sRGB color space. However, a significant fraction of human tissue colors exists outside of the sRGB color space and cannot be adequately captured by conventional image sensors or rendered on conventional displays operating within that color gamut. For example, ITU-R Recommendation BT.2020 (“Rec. 2020”) is a wider color system capable of capturing the sRGB color space, as well as the range of medical “reds” that cannot be adequately captured by conventional image sensors.

Regardless of the type of tissue the images of which the users seek to capture, the spectra and color come from the same set of features. In some embodiments, the inventive technology can capture the requisite colors for accurate images of human tissue based on the linear combinations of pixel responses having strong overlap with different wavelength bands or regions of color. This is complicated by the presence of blood in and around the tissue to be imaged—while light may be absorbed by the hemoglobin in blood, structural elements of the tissue may lead to background scattering. The combination of these aspects may shift the spectra of the light returning to the image sensor, thereby reducing the color accuracy of the resulting images. Therefore, color filters may be used to produce an ideal or close to ideal response. As such, the goal then becomes to modify and rearrange conventional color filters to more adequately capture bands of wavelengths where these confounding factors have the greatest impact, referred to herein as “blood absorption bands” (see FIG. 3D).

Conventional image sensors utilize a pixel array for capturing images, where each pixel array is comprised of a number of subpixels and a number of color filters. Each subpixel has at least one photodiode corresponding to each color filter. Conventional image sensors typically array these color filters in a two-dimensional grid (also referred to as a mosaic) with rows and columns. The grid is typically arranged in a Bayer filter pattern—where individual filters alternate colors by their respective rows and columns—with 50% green filters, 25% red filters, and 25% blue filters. As discussed above, this conventional arrangement often fails to accurately capture all of the hues necessary to distinguish different types of tissue within particular wavelength bands (e.g., blood absorption bands), where shades of red may be lost due to background scattering.

The inventive technology utilizes another filter pattern. For example, the inventive technology may utilize green, red, blue, and orange filters in equal quantities (a 25% distribution for each color). Furthermore, the inventive technology may adjust the absorption edges of the red and green color filters operating ranges to account for the newly added orange filter. Color filters may be made of a colored transparent material that absorbs light of specific wavelengths based upon the color of the filter and the exact composition of the material. Each color filter has one or more absorption edges limiting the range of wavelength absorption. The absorption edges represent a sharp discontinuity in the absorption spectrum of the filter's material and define the absorption/transmission ranges for which the most light may be transmitted through the filter (i.e. a transmittance greater than or equal to approximately 0.5). Filters that transmit light having a wavelength longer than a certain limiting wavelength (a low absorption edge) are known as high-pass filters. Filters that transmit light having a wavelength shorter than a certain limiting wavelength (a high absorption edge) are known as low-pass filters. Filters that have both low and high absorption edges and transmit light having a wavelength between these edges are known as band-pass filters.

These absorption edges may be adjusted by modifying the chemical or molecular formulation of the filter. For example, a conventional red high-pass color filter may have a low absorption edge around 585 nm; however, the inventive technology may use a red high-pass color filter having a low edge of 610 nm. Furthermore, a conventional green band-pass color filter may have a low edge around 478 nm and a high edge of 595 nm; however, the inventive technology may use a green band-pass color filter having an upper edge of around 565 nm. These adjustments—in addition to maintaining the typical edges for a blue band-pass color filter with a low edge around 390 nm and a high edge around 510 nm, as well as adding an orange wavelength high-pass color filter with a low edge around 540 nm—are included in the inventive technology.

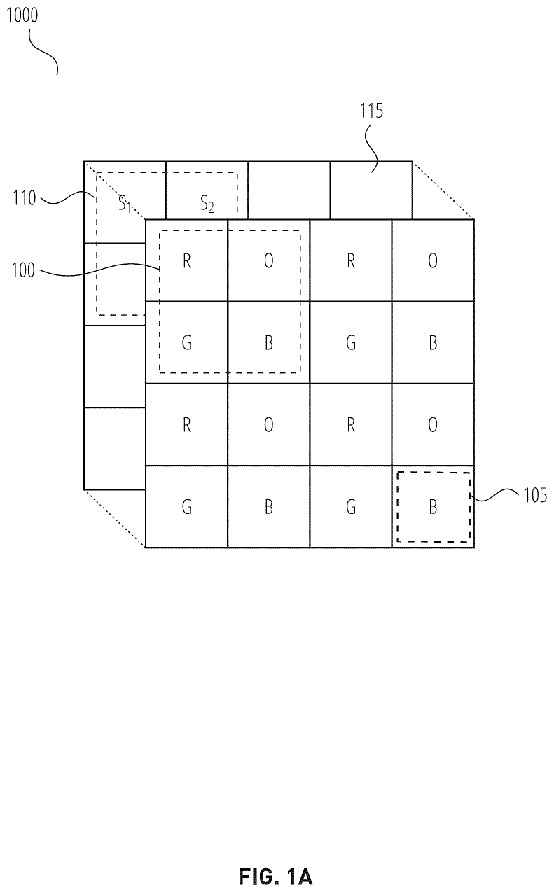

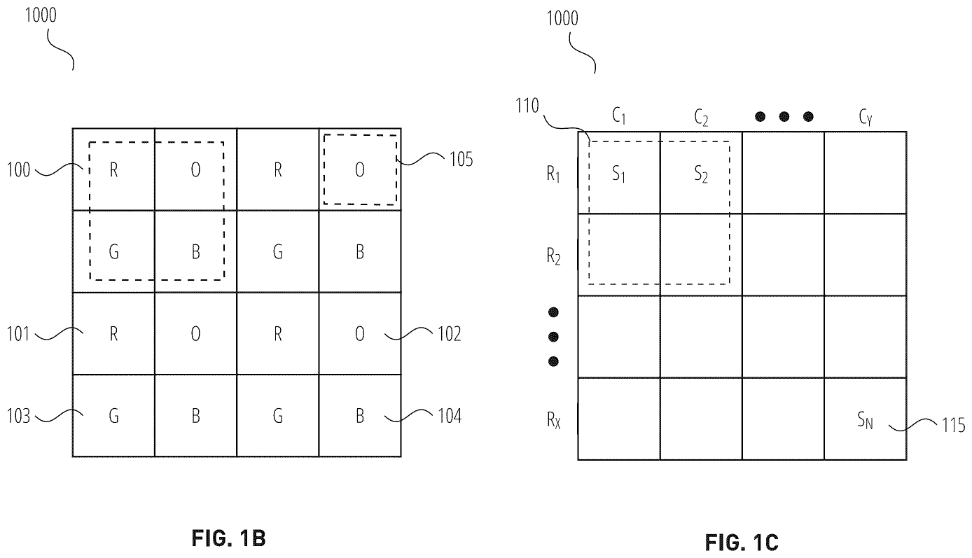

FIG. 1A, FIG. 1B, and FIG. 1C illustrate non-limiting example embodiments of a pixel array, according to various aspects of the present disclosure. In some embodiments, the pixel array 1000 may include a plurality of color filters 105 (as illustrated in FIG. 1B) and a plurality of subpixels 115 (as illustrated in FIG. 1C). It will be appreciated that while the illustrated embodiments feature Bayer cells 100 having four subpixels, each of pixels 110 having color filters 105, subpixels 115 and photodiodes 207, the embodiments described herein are not strictly limited to the illustrated number of these elements, nor are they limited to any specific multiples thereof.

As shown in the example illustrated in FIG. 1A, each pixel 110 of the pixel array 1000 may include a plurality of subpixels 115 and a plurality of color filters 105. In some embodiments, the plurality of color filters 105 may be organized into Bayer cells 100. In some embodiments, the number of subpixels 115 in a pixel 110 corresponds to the number of color filters 105 in a Bayer cell 100, that is, each subpixel 115 is mated to one color filter 105. However, in different embodiments, one color filter 105 may cover multiple subpixels 115.

As shown in the examples illustrated in FIG. 1B and FIG. 1C, each pixel 110 of the pixel array 1000 may include a Bayer cell 100, which may include a plurality of color filters 105. In some embodiments, the plurality of color filters 105 is configured to generate color-accurate images of biological tissue within a Rec. 2020 color gamut (illustrated in FIG. 3A). In some embodiments, the biological tissue is human tissue.

The plurality of color filters 105 may include a red wavelength high-pass color filter 101, an orange wavelength high-pass color filter 102, a green wavelength band-pass color filter 103, and a blue wavelength band-pass color filter 104. In some embodiments, the red wavelength high-pass color filter 101 has a wavelength edge (also referred to as “edge” for simplicity and brevity) at 610 nm±10 nm. In some embodiments, the orange wavelength high-pass color filter 102 has a wavelength edge at 540 nm±10 nm. In some embodiments, the green wavelength band-pass color filter 103 has a low wavelength edge at 478 nm±10 nm and a high wavelength edge at 565 nm±10 nm. In some embodiments, the blue wavelength band-pass color filter 104 has a low wavelength edge at 390 nm±10 nm and a high wavelength edge at 510 nm±10 nm. The plurality of color filters 105 may be comprised of an equal number of red wavelength high-pass color filters 101, orange wavelength high-pass color filters 102, green wavelength band-pass color filters 103, and blue wavelength band-pass color filters 104. In some embodiments, a Bayer cell 100 includes one of each color filter 101, 102, 103, 104.

Each color filter 105 may cover a subpixel 115. Both the plurality of color filters 105 and the plurality of subpixels 115 may be arranged into rows R₁ to Rₓ and columns C₁ to C_{y} to acquire image data of a person, place or object, including biological tissues, which can then be used to render an image of the person, place or object, including biological tissues.

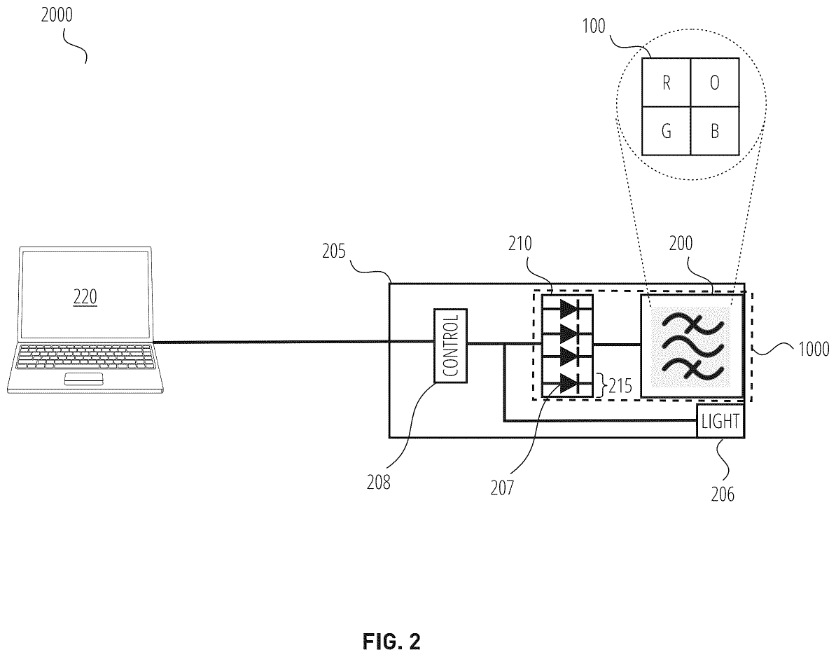

In some embodiments, the individual color filters 105 alternate colors by their respective rows and columns. In the embodiment illustrated in FIG. 1A and FIG. 1B, the red wavelength high-pass color filters 101 and orange wavelength high-pass color filters 102 alternate in the first row (R₁ in FIG. 1C); while the green wavelength band-pass color filters 103 and blue wavelength band-pass color filters 104 alternate in the second row (R₂ in FIG. 1C). These color filters 105 correspond to the subpixels 115 in R₁ and R₂ in FIG. 1C, respectively. Columns may alternate in the same way, albeit with different colors based upon their arrangement (e.g., red wavelength high-pass color filters 101 and green wavelength band-pass color filters 103 may alternate in one column while orange wavelength high-pass color filters 102 and blue wavelength band-pass color filters 104 may alternate in the next). In some embodiments, each subpixel 115 includes at least one photodiode (as illustrated in FIG. 2).

FIG. 2 illustrates a non-limiting example embodiment of a system for generating color-accurate images of biological tissue, according to various aspects of the present disclosure. In some embodiments, the system 2000 includes an image sensor 205, and a processor 220. In some embodiments, the image sensor 205 is configured to capture and transmit an image of biological tissue. In some embodiments, the biological tissue is human tissue. The image sensor 205 may include a pixel array 1000, a control unit 208, and a light source 206.

In some embodiments, the pixel array 1000 includes one or more pixels 210, each including a plurality of subpixels 215 and a plurality of color filters 200. In some embodiments, each subpixel 215 includes at least one photodiode 207. In some embodiments, individual color filters 200 only allow for the transmission of select wavelengths of light. These color filters 200 may be high-pass color filters, low-pass color filters, or band-pass color filters based on the objects to be captured. In the illustrated embodiment, the system 2000 incorporates pixel array 1000, which in turn utilizes one or more Bayer cells 100 as described in FIG. 1A, FIG. 1B, and FIG. 1C. In some embodiments, the plurality of color filters 200 may further include an infrared cut-off filter configured to reflect or absorb near-infrared wavelengths of light.

The control unit 208 may also be electrically coupled to the color filter 200, photodiodes 207 and the light source 206, such that the control unit 208 may control the operation of these elements based upon input from the user either via the processor 220 or by manipulating the image sensor 205 directly through a user interface system (not pictured). In some embodiments, the user interface system may include buttons, switches, a touchscreen, or a combination thereof. In some embodiments, the control unit 208 is configured to apply the plurality of color filters 200 to the image of biological tissue captured by the image sensor 205. In some embodiments, the image sensor 205 is configured to transmit the image of biological tissue to another device, such as the processor 220 for further processing.

In one example, image sensor 205 may be included in a medical imaging device such as an endoscope or the like. Additionally, image sensor 205 may be coupled to other pieces of hardware such as a processor 220 (general purpose or otherwise), which may include further memory elements, output (USB port, wireless transmitter, HDMI port, etc.), lighting/flash, electrical input (keyboard, touch display, track pad, mouse, microphone, etc.), and/or display. In some embodiments, processor 220 is configured to receive and display the image of biological tissue captured by the image sensor 205. In some embodiments, the processor 220 may be configured to apply additional filters to the image received from the image sensor 205 or manipulate the image to generate a color-accurate image of biological tissue that is clear, sharp, and usable for medical purposes (e.g., diagnosis of human tissue). In other embodiments, other pieces of hardware may deliver instructions to image sensor 205, extract image data from image sensor 205, or manipulate image data supplied by image sensor 205. In some embodiments, the processor 220 is configured to display the Rec. 2020 Color Gamut.

In some embodiments, the light source 206 is a Red-Green-Blue (RGB) light-emitting diode (LED). In other embodiments, other light sources 206 may be used, including natural light.

FIG. 3A is a graphical depiction of the sRGB color space (also referred to herein as the sRGB Color Gamut) and the Rec. 2020 color space (also referred to herein as the Rec. 2020 Color Gamut) within the context of the full range of human vision, according to the CIE 1931 Standard xy chromaticity diagram. In the diagram, the horizontal and vertical axes correspond to xy chromaticity (regardless of illuminance), where x and y are normalized functions of the tristimulus values (X, Y, Z) of the CIE color space such that

$$= \frac{X}{X + Y + Z} , y = \frac{Y}{X + Y + Z} ,$$

and the shaded curve outlines the full range of human vision. The solid triangle outlines the sRGB Color Gamut 301, which describes the range of colors that can be captured using conventional color filter technology. The dotted triangle encompassing the sRGB Color Gamut 301 outlines the Rec. 2020 Color Gamut 302, which captures an additional range of red hues covered by the example embodiments of the inventive technology disclosed herein. The sRGB Color Gamut 302 may be understood as a target area of operation for an endoscopic image sensor according to the inventive technology.

FIG. 3B illustrates a non-limiting example embodiment of a simulated color filter response, according to various aspects of the conventional technology. The horizontal axis corresponds to the wavelength of incident light in nanometers (nm), while the vertical axis corresponds to the transmittance of the filter from 0 to 1, where 0 is equivalent to no light of the given wavelength passing through the filter (total reflection or absorption) and 1 is equivalent to all light of the passing through the filter (total transmittance). Conventional image sensors typically array color filters in a two-dimensional grid (also referred to as a mosaic) with rows and columns. The conventional grid is typically arranged in a Bayer filter ttern—where individual filters alternate colors by their respective rows and columns—with 50% green wavelength band-pass color filters, 25% red wavelength high-pass color filters, and 25% blue wavelength band-pass color filters. As discussed above and illustrated in the disclosed graph, a conventional green wavelength band-pass color filter may have a low edge around 478 nm and a high edge of 595 nm, between which the filter allows the most light to transmit, or pass through. A conventional red wavelength high-pass color filter may have a low absorption edge around 585 nm, after which the filter transmits the most light. Finally, a conventional blue wavelength band-pass color filter may have a low absorption edge around 385 nm and a high absorption edge around 505 nm, between which the filter transmits the most light.

FIG. 3C illustrates a non-limiting example embodiment of a simulated color filter response, according to various aspects of the present disclosure. The horizontal axis corresponds to the wavelength of incident light in nanometers (nm), while the vertical axis corresponds to the transmittance of the filter from 0 to 1, where 0 is equivalent to no light of the given wavelength passing through the filter (total reflection or absorption) and 1 is equivalent to all light of the passing through the filter (total transmittance). The illustrated embodiment utilizes a Bayer filter pattern with green wavelength band-pass color filters, red wavelength high-pass color filters, blue wavelength band-pass color filters, and orange wavelength high-pass color filters in equal quantities (a 25% distribution for each color). According to the example embodiment, the green wavelength band-pass color filter may have a low absorption edge around 478 nm and a high absorption edge of 595 nm; the red wavelength high-pass color filter may have a low absorption edge around 610 nm; the blue wavelength band-pass color filter may have a low absorption edge around 385 nm and a high absorption edge around 505 nm; and the Orange Wavelength High-Pass color filter may have a low absorption edge around 540 nm.

FIG. 3D illustrates non-limiting example embodiments of simulated color filter responses, according to various aspects of both the conventional technology and the present disclosure. Illustrated is a series of non-limiting example embodiments of the conventional color filter response (RGGB, middle graph) and the inventive color filter response (ROGB, bottom graph) in the context of example measurements of relative intensity of imaged tissue at different wavelengths (top graph). The horizontal axes of all three graphs correspond to the wavelength of incident light in nanometers (nm). The vertical axis of the color filter response graphs (middle and bottom) corresponds to the transmittance of the filter from 0 to 1, where 0 is equivalent to no light of the given wavelength passing through the filter (total reflection or absorption) and 1 is equivalent to all light of the passing through the filter (total transmittance). The vertical axis of the intensity graph (top) corresponds to the relative intensity of incident light measured by an exemplary image sensor measured in arbitrary units (au). Referring to the top graph, measurements were collected for normal tissue (in black), adenocarcinoma tissue (in red), and dysplastic tissue (in blue). It will be appreciated that these examples are non-limiting and that the applications of the inventive color filter arrangement extend beyond these three use-cases. Referring to these measurements, a prominent drop in intensity is visible within the shaded portions of the graph, indicating two of the blood absorption bands 303 described above, indicating a higher concentration of blood that reduces the clarity and efficacy of the resulting images within that range of wavelengths. As such, a pixel array for an image sensor having a plurality of color filters having a higher transmittance within these blood absorption bands 303 is capable of producing clearer, more color-accurate images of tissue under these conditions.

Referring to the conventional filter response, there is a noticeable decrease in transmission within the second blood absorption band 303 (from approximately 520 nm to 610 nm). At approximately 575 nm, the conventional green wavelength band-pass color filter dips below 0.5 transmittance before the edge of the conventional red wavelength high-pass color filter rises above the same threshold. This drop in transmittance results in a reduction in the color accuracy of the collected images within this blood absorption band 303.

Referring to the inventive filter arrangement, the shifts in edges of the red wavelength high-pass color filter and green wavelength band-pass color filter, as well as the introduction of the orange wavelength high-pass color filter as described above effectively mitigate the reduced transmittance found in the conventional filter response, resulting in more color-accurate images for wavelengths of light within the blood absorption bands 303. By introducing the orange wavelength high-pass color filter (and accompanying photodiode(s)), the transmittance of the filter arrangement within the second blood absorption band increases such that the lowest transmittance within the target range is no lower than 0.6 (at the intersection of the green and orange filter responses, or approximately 530 nm). As a result, the image captured using the inventive filter has greater color accuracy within this blood absorption band.

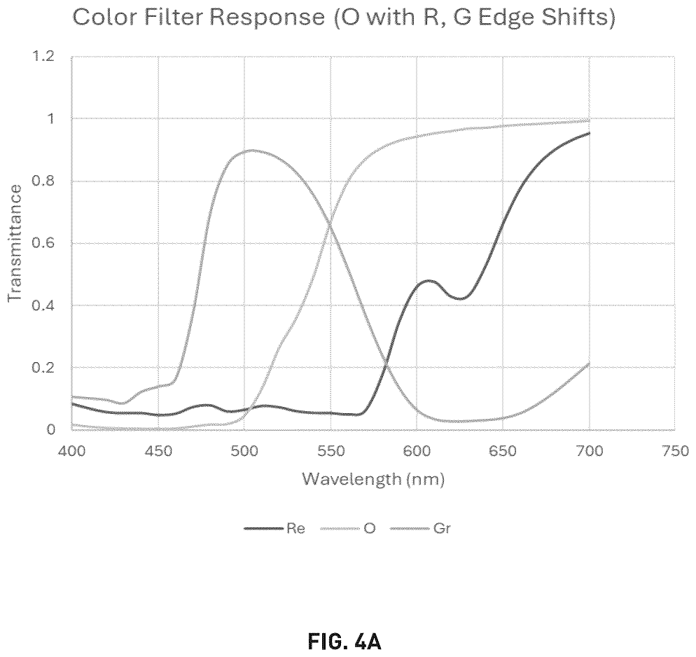

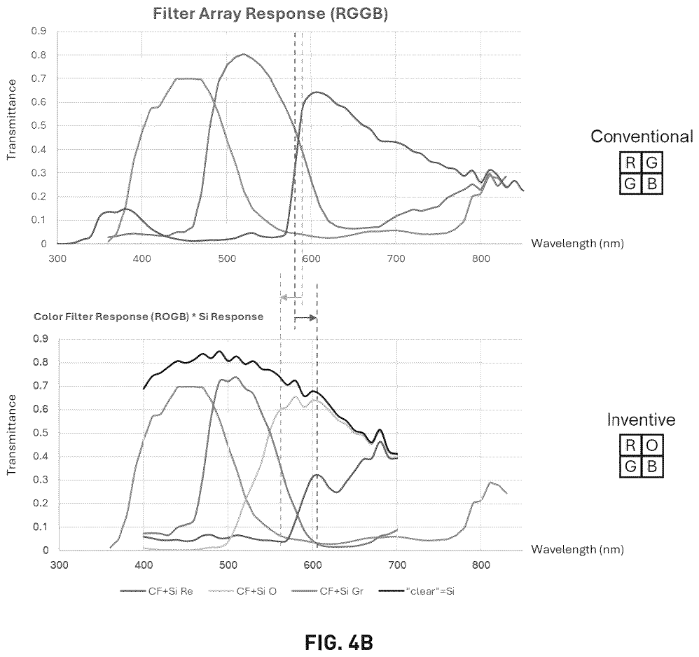

FIG. 4A and FIG. 4B illustrate a non-limiting example embodiment of a simulated color filter response, according to various aspects of the present disclosure.

FIG. 4A illustrates individual color filter responses according to an example embodiment of the inventive technology, specifically the red wavelength high-pass color filter and green wavelength band-pass color filter modified from the conventional filters of that color described above, as well as the added Orange Wavelength High-Pass color filter. The horizontal axis corresponds to the wavelength of incident light in nanometers (nm), while the vertical axis corresponds to the transmittance of the filter from 0 to 1, where 0 is equivalent to no light of the given wavelength passing through the filter (total reflection or absorption) and 1 is equivalent to all light of the passing through the filter (total transmittance). According to the example embodiment, the green wavelength band-pass color filter may have a low absorption edge around 478 nm and a high absorption edge of 595 nm; the red wavelength high-pass color filter may have a low absorption edge around 610 nm; the blue wavelength band-pass color filter may have a low absorption edge around 385 nm and a high absorption edge around 505 nm; and the Orange Wavelength High-Pass color filter may have a low absorption edge around 540 nm.

FIG. 4B highlights the changes between the conventional (top graph) and inventive (bottom graph) technologies. The horizontal axes of both graphs correspond to the wavelength of incident light in nanometers (nm), while the vertical axes correspond to the transmittance of the filter from 0 to 1, where 0 is equivalent to no light of the given wavelength passing through the filter (total reflection or absorption) and 1 is equivalent to all light of the passing through the filter (total transmittance). FIG. 4B compares the conventional color filter responses as described in FIG. 3B with the inventive color filter responses, the latter of which is multiplied by the “silicon response” to produce a simulated response that factors in the quantum efficiency (QE) of the imaging device as a result of the inventive filter described in FIG. 3C.

As can be observed in the graphs, the conventional red wavelength high-pass color filter has a low absorption edge around 585 nm, while inventive red wavelength high-pass color filter has a low absorption edge that has been shifted up to 610 nm. Additionally, the conventional green wavelength band-pass color filter has a low edge around 478 nm and a high edge of 595 nm, while the inventive green wavelength band-pass color filter has an upper edge that has been modified down to around 565 nm. The orange wavelength high-pass color filter has been added to the inventive technology and has a low absorption edge around 540 nm. Finally, the blue wavelength band-pass color filter is unchanged from the conventional technology. When compared to a notional clear filter (in black), the response of the orange wavelength high-pass color filter and red wavelength high-pass color filter closely follows what would be an ideal color filter response for the region of “reds” that are most often present in human tissue imaging.

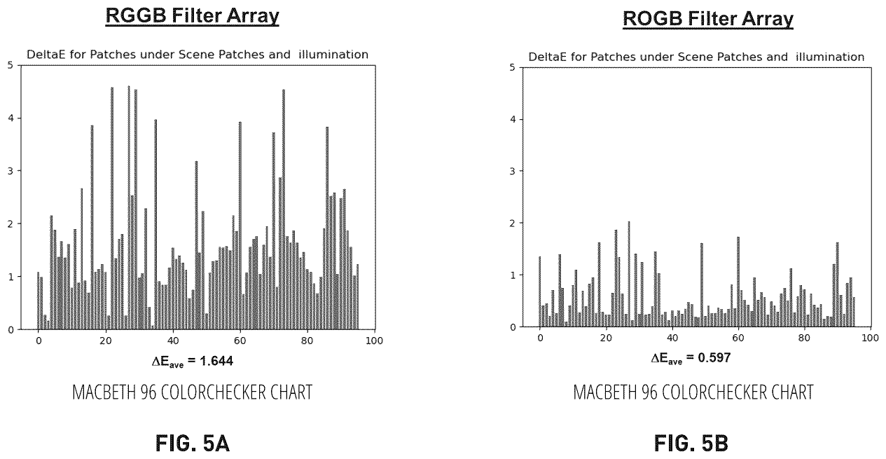

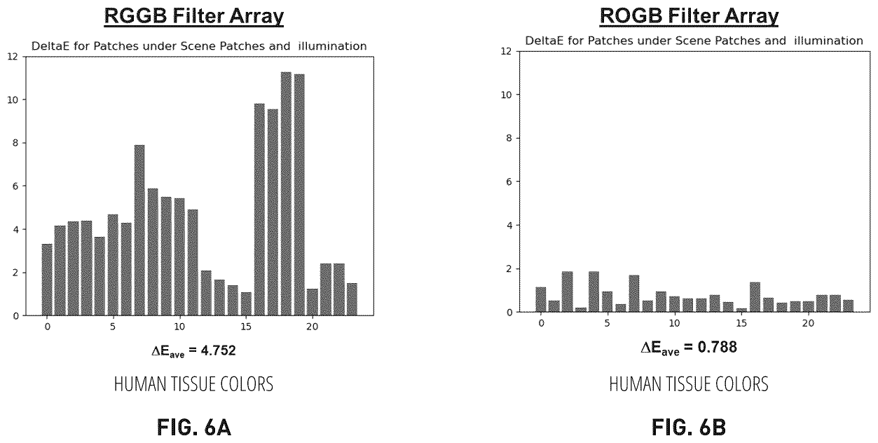

FIG. 5A, FIG. 5B, FIG. 6A, and FIG. 6B illustrate performance results of the non-limiting example embodiments of color filters according to various aspects of both the conventional technology and the present disclosure. Each figure depicts the color accuracy of the respective filters by measuring the difference between a given color and the color received by a simulated image sensor in a three-dimensional L*a*b* color space. In this color space, L* is a vertical light to dark measurement with a range of 0-100, where zero is black (a perfect absorber) and 100 is white (a perfect reflecting diffuser); a* is a horizontal, left to right, green (negative) to red (positive) measurement with no specific numerical limit (positive is red and negative is green; and b* is a horizontal, back to front, blue (negative) to orange (positive) measurement with no specific numerical limit. With both the given color and the color received assigned numerical values within the L*a*b* color space, the difference between the two—or more precisely, the deviation of the received color from the given color—is calculated (ΔE), where

$$Δ E = {[ {( {L}_{2}^{*} - {L}_{1}^{*} )}^{2} + {( {a}_{2}^{*} - {a}_{1}^{*} )}^{2} + {( b * 2 - {b}_{1}^{*} )}^{2} ]}^{1 / 2} .$$

When evaluating these measurements, a lower ΔE indicates less deviation, meaning a more accurate color received by the image sensor. The horizontal axes for all graphs correspond to the wavelength of incident light in nanometers (nm), while the vertical axes correspond to calculated ΔE at each wavelength.

FIG. 5A depicts the performance of a filter according to the conventional technology (RGGB) evaluated against the MacBeth 96 Color Patch Chart, which is an assortment of 96 colors from across the CIE 1931 color standard (see FIG. 3A). Across this broader range of colors, the conventional filter produces an average ΔE of 1.644. Comparatively, FIG. 5B depicts the performance of a filter according to the inventive technology (ROGB) evaluated against the same MacBeth 96 Color Patch Chart. Across this range of colors, the inventive filter produces an average ΔE of 0.597, indicating a notable decrease in error using the inventive technology and greater color accuracy.

FIG. 6A depicts the performance of a filter according to the conventional technology (RGGB) evaluated against selected colors from the MacBeth 96 Color Patch Chart that most closely correspond with human tissue. Focusing on this narrower range of colors, the conventional filter produces an average ΔE of 4.752. Comparatively, FIG. 6B depicts the performance of a filter according to the inventive technology (ROGB) evaluated against the same selected colors from the MacBeth 96 Color Patch Chart. Across this range of colors, the inventive filter produces an average ΔE of 0.788, indicating a significant decrease in error using the inventive technology and greater color accuracy for a range of colors that are most directly applicable to medical imaging and endoscopy.

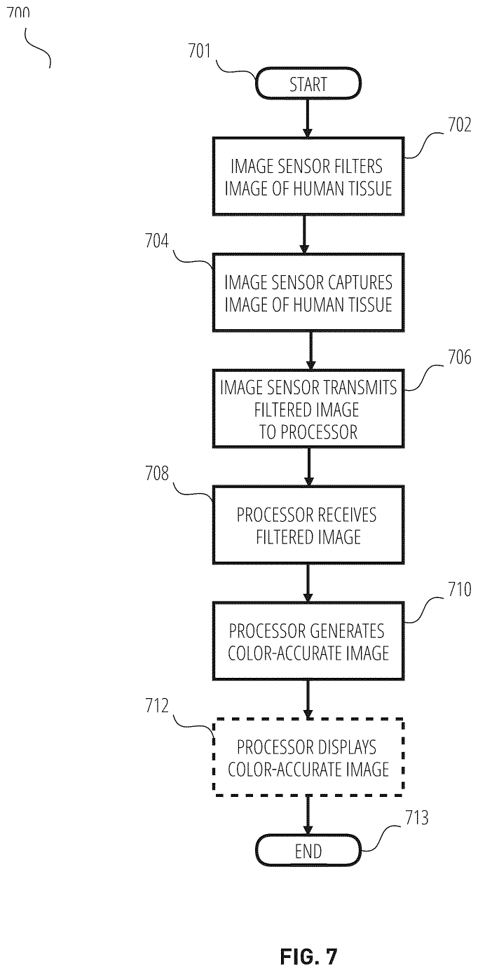

FIG. 7 illustrates a method 700 for generating and displaying color-accurate images of biological tissue, according to various aspects of the present disclosure. It should be understood that components referred to in this figure are analogous to components identified in the system 2000 described in FIG. 2. In different embodiments, the sample method may operate without applying all the illustrated steps or may include the steps that are not illustrated in the flowchart.

From a START block 701, the method 700 proceeds to block 702, where the image sensor 205 filters incident light corresponding to an image of biological tissue through the plurality of color filters 200. In some embodiments, the plurality of color filters 200 only allow for the transmission of select wavelengths of light. These color filters 200 may be high-pass color filters, low-pass color filters, or band-pass color filters based on user need and the objects to be captured (e.g., Bayer cells 100 as described in FIG. 1A, FIG. 1B, and FIG. 1C). In some embodiments, the plurality of color filters 200 may further include an infrared cut-off filter configured to reflect or absorb near-infrared wavelengths of light.

The filtered incident image light then proceeds to the image sensor 205, which captures the image of biological tissue corresponding to the filtered light in process block 704. In one example, image sensor 205 may be included in a medical imaging device such as an endoscope or the like. In some embodiments, the image sensor 205 includes a pixel array 1000, a control unit 208, and a light source 206. In some embodiments, the pixel array 1000 includes one or more pixels 210, each of which includes a plurality of subpixels 215 and a plurality of color filters 200. In some embodiments, each subpixel 215 includes at least one photodiode 207. The control unit 208 may also be electrically coupled to the photodiodes 207 and the light source 206, such that the control unit 208 may control the operation of these elements based upon input from the user either via the processor 220 or by manipulating the image sensor 205 directly through a user interface system (not pictured). In some embodiments, the user interface system may include buttons, switches, a touchscreen, or a combination thereof. In some embodiments, the light source 206 is a Red-Green-Blue (RGB) light-emitting diode (LED). In other embodiments, other light sources 206 may be used.

In process block 706, the image sensor 205 may transmit the filtered image to a processor 220 for further processing. Image sensor 205 may be coupled to other pieces of hardware such as a processor 220 (general purpose or otherwise), which may include further memory elements, output (USB port, wireless transmitter, HDMI port, etc.), lighting/flash, electrical input (keyboard, touch display, track pad, mouse, microphone, etc.), and/or display.

In process block 708, the processor 220 may receive the filtered image from the image sensor 205.

In process block 710, the processor 220 may generate a color-accurate image. In some embodiments, the processor 220 may apply additional filters to the image received from the image sensor 205 or manipulate the image to generate a color-accurate image of biological tissue that is clear, sharp, and usable for medical purposes (e.g., diagnosis). In other embodiments, other pieces of hardware may deliver instructions to image sensor 205, extract image data from image sensor 205, or manipulate image data supplied by image sensor 205.

In optional process block 712, the processor 220 may display the color-accurate image. In some embodiments, the processor 220 is configured to display the Rec. 2020 Color Gamut.

The method 700 then proceeds to an END block 713 and terminates.

It should be understood that method 700 should be interpreted as merely representative. In some embodiments, process blocks of method 700 may be performed simultaneously, sequentially, in a different order, or even omitted, without departing from the scope of this disclosure.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access Memory (RAM), Dynamic Random Access Memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

What is claimed is:

1. A pixel array for generating color-accurate images of biological tissue, wherein each pixel of the pixel array comprises:
a plurality of subpixels, wherein each subpixel has at least one photodiode; and
a plurality of color filters comprising:
a red wavelength high-pass color filter;
an orange wavelength high-pass color filter;
a green wavelength band-pass color filter; and
a blue wavelength band-pass color filter.

2. The pixel array of claim 1,
wherein the plurality of color filters are arranged in a two-dimensional grid having a plurality of rows and columns; and
wherein individual filters of the plurality of color filters alternate colors by their respective rows and columns.

3. The pixel array of claim 1, wherein:
the red wavelength high-pass color filter has an edge at 610 nm±10 nm;
the orange wavelength high-pass color filter has an edge at 540 nm±10 nm;
the green wavelength band-pass color filter has a low edge at 478 nm±10 nm and a high edge at 565 nm±10 nm; and
the blue wavelength band-pass color filter has a low edge at 390 nm±10 nm and a high edge at 510 nm±10 nm.

4. The pixel array of claim 1, wherein the pixel array is configured to generate color-accurate images of biological tissue within a Rec. 2020 color gamut.

5. The pixel array of claim 1, wherein the plurality of color filters is comprised of an equal number of red wavelength high-pass color filters, orange wavelength high-pass filters, green wavelength band-pass color filters, and blue wavelength band-pass color filters.

6. A system for generating color-accurate images of biological tissue comprising:
an image sensor configured to capture and transmit an image of biological tissue, comprising:
a pixel array, wherein each pixel of the pixel array comprises:
a plurality of subpixels, wherein each subpixel has at least one photodiode; and
a plurality of color filters comprising:
a red wavelength high-pass color filter;
an orange wavelength high-pass color filter;
a green wavelength band-pass color filter; and
a blue wavelength band-pass color filter;
a light source; and
a control unit, wherein the control unit is electrically coupled to the pixel array and the light source; and
a processor configured to receive the image of biological tissue.

7. The system of claim 6,
wherein the plurality of color filters is arranged in a two-dimensional grid having a plurality of rows and columns; and
wherein individual filters of the plurality of color filters alternate colors by their respective rows and columns.

8. The system of claim 6, wherein:
the red wavelength high-pass color filter has an edge at 610 nm±10 nm;
the orange wavelength high-pass color filter has an edge at 540 nm±10 nm;
the green wavelength band-pass color filter has a low edge at 478 nm±10 nm and a high edge at 565 nm±10 nm; and
the blue wavelength band-pass color filter has a low edge at 390 nm±10 nm and a high edge at 510 nm±10 nm.

9. The system of claim 6, wherein the pixel array is configured to generate color-accurate images of biological tissue within a Rec. 2020 color gamut.

10. The system of claim 6, wherein the plurality of color filters is comprised of an equal number of red wavelength high-pass color filters, orange wavelength high-pass filters, green wavelength band-pass color filters, and blue wavelength band-pass color filters.

11. The system of claim 6, wherein the control unit is configured to apply the plurality of color filters to the image of biological tissue.

12. The system of claim 6, wherein the plurality of color filters further comprises an infrared cut-off filter.

13. The system of claim 6,
wherein the image sensor is electrically coupled to the processor; and
wherein the image sensor is configured to transmit the image of biological tissue to the processor through a physical connection.

14. A method for generating and displaying color-accurate images of biological tissue, comprising:
filtering, by an image sensor, an image of biological biological tissue, wherein the image sensor comprises:
a pixel array, wherein each pixel of the pixel array comprises:
a plurality of subpixels, wherein each subpixel has at least one photodiode; and
a plurality of color filters comprising:
a red wavelength high-pass color filter;
an orange wavelength high-pass color filter;
a green wavelength band-pass color filter; and
a blue wavelength band-pass color filter;
a light source; and
a control unit, wherein the control unit is electrically coupled to the pixel array and the light source;
capturing, by the image sensor, the image of biological tissue;
transmitting, by the image sensor, a filtered image of biological tissue to a processor;
receiving, by the processor, the filtered image of biological tissue; and
generating, by the processor, a color-accurate image of biological tissue.

15. The method of claim 14,
wherein the plurality of color filters are arranged in a two-dimensional grid having a plurality of rows and columns; and
wherein individual filters of the plurality of color filters alternate colors by their respective rows and columns.

16. The method of claim 14, wherein:
the red wavelength high-pass color filter has an edge at 610 nm±10 nm;
the orange wavelength high-pass color filter has an edge at 540 nm±10 nm;
the green wavelength band-pass color filter has a low edge at 478 nm±10 nm and a high edge at 565 nm±10 nm; and
the blue wavelength band-pass color filter has a low edge at 390 nm±10 nm and a high edge at 510 nm±10 nm.

17. The method of claim 14, wherein the pixel array is configured to generate color-accurate images of biological tissue within a Rec. 2020 color gamut.

18. The method of claim 14, wherein the plurality of color filters is comprised of an equal number of red wavelength high-pass color filters, orange wavelength high-pass filters, green wavelength band-pass color filters, and blue wavelength band-pass color filters.

19. The method of claim 14, wherein the image sensor further comprises an infrared cut-off filter.

20. The method of claim 14,
wherein the image sensor is electrically coupled to the processor; and
wherein the image sensor is configured to transmit the image of biological tissue to the processor through a physical connection.
